(19) United States
(12) Patent Application Publication
(10) Pub. No.: US 2002/0095228 A1
(43) Pub. Date: Jul. 18, 2002

(54) System for implementing radio commerce

(76) Inventors: David Corts, New York, NY (US); Bryce Wells, Darien, CT (US); Paul Signorelli, New York, NY (US); Lee Hunter, Darien, CT (US); Terrance Snyder, (US)

Correspondence Address: BANNER & WITCOFF, LTD., 28 STATE STREET, 28th FLOOR, BOSTON, MA, 02109, US

(21) Appl. No.: 09/802,469

(22) Filed: Mar. 9, 2001

Related U.S. Application Data
(60) Provisional application No. 60/188,050, filed on Mar. 9, 2000.

(51) Int. Cl. G06F 17/00

(52) U.S. Cl. 700/94

(57) ABSTRACT

The present invention is a computer based system that allows digital audio broadcasters to produce an entertaining interactive flow of digital information for commercial purposes, place advertising within it, control the timing, flow and occurrence of that data as it will be delivered to a consumer. This system is called R-COMMERCE.™

### CROSS-REFERENCE TO RELATED APPLICATION

This application claims priority from a now abandoned provisional application, U.S. Ser. No. 60/188,050, filed March 9, 2000, the disclosure of which is hereby incorporated herein by reference.

### BACKGROUND OF THE INVENTION

In-Band On-Channel (IBOC) is an emerging Digital Audio Broadcasting (DAB) technology, developed by iBiquity Digital, Inc., that enables radio broadcasters to transmit digital data (“the data”) over their current analog transmission frequencies—which are typically used for the transmission of audio broadcasts. IBOC technology has the ability to create a “hybrid” signal that can simultaneously send analog (“audio”) and digital data. The digital data can be digitally compressed analog (“audio”) data, instructions for rendering visual components (“visual data”) on an IBOC DAB receiver, or information for other data-specific services. For example, digital data could potentially render visual components such as artist/song title information, news headlines, digital audio traffic reports or other information that could be valuable to a radio listener. U.S. Pat. No. 5,757,854 discusses these capabilities in greater detail.

This invention also relates to advertising and the companies that serve the advertising industry in the capacity of creating advertisements for a specific medium as well as the development of intelligent tools to efficiently and strategically place advertisements. With regards to advertising on the World Wide Web, multiple companies have developed creative tools for the production of “web banners” and web pages where those banners are typically found. DoubleClick, Inc., has developed and patented a process for intelligently distributing these banners across a network of web sites for maximum reach and efficiency.

This invention also relates to the aggregation of content from multiple providers and the redistribution and repurposing of that content for different media. InfoSpace is perhaps the clearest example of a company whose core business is to aggregate content from multiple providers into a central space that is repackaged and licensed to other entities wishing to utilize that content—such as other web sites and wireless network providers. For example, InfoSpace collects content on a multitude of subjects and then licenses that content (or selected “chunks” of that content) to Verizon Wireless, a wireless communications company, for the purposes of supplying their WAP enabled users content to their mobile phones.

Other digital radio patents include the following; U.S. Pat. No. 6,148,007, U.S. Pat. No. 6,128,350, U.S. Pat. No. 6,128,334, U.S. Pat. No. 6,108,810, U.S. Pat. No. 6,005,886, U.S. Pat. No. 5,956,624, U.S. Pat. No. 5,956,373, U.S. Pat. No. 5,949,813, U.S. Pat. No. 5,930,687, U.S. Pat. No. 5,903,598, U.S. Pat. No. 5,898,732, U.S. Pat. No. 5,878,089, U.S. Pat. No. 5,850,415, U.S. Pat. No. 5,809,065, U.S. Pat. No. 5,764,706, U.S. Pat. No. 5,745,525, U.S. Pat. No. 5,703,954, U.S. Pat. No. 5,633,896, U.S. Pat. No. 5,465,396, U.S. Pat. No. 5,315,583, U.S. Pat. No. 5,278,844, U.S. Pat. No. 5,278,826, the disclosures of which are hereby incorporated herein by reference.

### SUMMARY OF THE INVENTION

The present invention embodies a series of sub-systems (cooperating hardware and software) that allow a broadcaster to utilize IBOC technology to broadcast digitized data (“data”) along with the digital audio (“audio”) that enhances the value of a radio broadcast. This process shall herein be referred to as “data-casting” or “broadcasting” and the broadcast itself can be referred to as a “data-cast”. Additionally, embodiments of the present invention advantageously provide a useful and unrealized commercial utility, radio commerce (“rCommerce”), to an existing IBOC technology.

Certain embodiments provide a methodology and a system for creating data, managing data, associating data with audio, scheduling data for broadcast, and tracking production and sales information in regards to the data. Furthermore these embodiments provide a methodology and a system for identifying characteristics of the audio and the data that trigger the transmission of data within a broadcast as well as characteristics regarding the continuity of the data presentation, such as the timing and positioning during the broadcast.

Other embodiments of the present invention provide a methodology and a system for connecting individual broadcasters engaged in data-casting such that a single piece of data can be produced once and broadcast by all of the connected broadcasters. This is referred to from time-to-time herein as the “network” of broadcasters. Further embodiments of the invention provide a methodology and a system for centrally locating data within the network as well as a methodology and a system for moving data throughout the network.

Certain embodiments provide a methodology and a system for using the characteristics of the desired audience for a particular piece of data in combination with the identifiable characteristics regarding the audience of broadcasters within the network to schedule data throughout the network in a way that is optimal for the data. A basic example of this would be the scheduling of data designed as an advertisement to be broadcast by broadcasters within the network whose audience characteristics most closely match the desired characteristics of the advertiser.

Other embodiments of the invention provide a methodology and a system for monitoring the activity of a broadcast, identifying individual audio elements within the broadcast, matching the criteria of the audio elements against the broadcast characteristics of all of the data available for the broadcast, and selecting the appropriate pieces of data for broadcast.

Further embodiments of the invention provide a methodology and a system for packaging a set of data with audio such that the timing of the presentation of one or more parts of the data can be correlated with the timing of events in the audio and this relationship can be understood by a device that renders the audio and the data simultaneously. A simple example of this would be to have a particular phrase of a song appear on a screen connected to the receiver as the phrase was being heard audibly. Furthermore, these embodiments provide a methodology and system for repeating the data within the package of data and audio to ensure that the receiver device receives all of the data and that the data can be fully received for presentation at any point during the broadcast.

An additional embodiment of the invention provides a methodology and a system for encoding the data with instructions that allow for the transmission of the data and the instructions to a device that can perform a task identified by the instructions.

The present invention thus creates a framework and suite of tools for IBOC broadcasters (herein referred to as “broadcaster” or “datacaster”) to create, manage and schedule digital data for transmission over their radio broadcast. The invention enables them to generate revenue from the transmission of digital data through advertising sponsorships, direct response fees, commerce transactions, and other revenue producing methods which are herein referred to as “rCommerce” or “radio commerce.”

Additionally, the present invention creates a network of datacasters consisting of every radio station that uses the invention, which is used by the assignee of this application, Impulse Radio, Inc., for rCommerce revenue through the efficient and strategic distribution of Impulse Radio, Inc., clients' digital data. Finally, the present invention develops the mechanisms by which all digital data travels through, and is accounted for in, the network of datacasters, regardless of the destination, purpose, or source of the digital data.

Specifically, the present invention defines a multipurpose device (herein referred to as “the black box” or “Internet appliance” and discussed in greater detail below that is responsible for the 1) temporary storage and constant dissemination of digital data to a DAB radio station, 2) communication with the invention's data repository to update digital data and 3) monitoring a DAB radio station's audio broadcast system for the presence of “opportunistic avails” in which commercial and non-commercial digital data is inserted.

The present invention is important because it provides broadcasters a “turn-key” solution for the development and management of digital data broadcast to their audiences. Some broadcasters will prefer to transmit digital data that are largely visual components designed to enhance the experience of the audio broadcast. Some broadcasters will prefer to transmit digital data that are higher-quality (in relation to the analog signal) audio signals, with little or no thought to visual components. Some broadcasters will even forgo audio altogether and utilize IBOC technology to transmit digital data for other point-to-multipoint data services.

The present invention is also important because it provides a useful commercial utility, radio commerce, to an existing IBOC technology. Currently the only commercial application for IBOC is the hybrid delivery of digital audio broadcasting. Commercial initiatives to increase the sound quality of an audio broadcast are underway by transmission equipment manufacturers and iBiquity Digital. This invention enables and makes commercial use of IBOC's data transmission capabilities that are currently unrealized.

The present invention is also important because it fundamentally changes the nature of a radio broadcast by adding datacast elements to an audio medium. In addition, it fundamentally changes the entertainment value of radio for a consumer through the use of these datacast elements and allowing the consumer to interact with them by way of response—i.e., the essence of “radio commerce.”

The present invention will clearly be of great importance to radio broadcasters. Currently, a radio broadcaster can derive revenue from approximately 20% of his available airtime in a best-case scenario. The present invention offers broadcasters the opportunity to transform the datacast elements into visual and adjunct audio advertisements and broadcast these datacast elements simultaneously with their traditional audio programming, in effect, tripling their current amount of advertising inventory. This increase allows a broadcaster to reach consumers with much greater frequency. Moreover, the present invention increases the value of a broadcaster's traditional audio advertising spot as it provides the ability to broadcast datacast elements that are designed as specific enhancements to the advertisement.

The present invention is likewise important to advertisers because the datacast elements offer heretofore unavailable creative opportunities for reaching consumers through the radio—including brand images, product photos, special audio messages and the like. Such datacast elements present advertisers the ability to have their brand messages displayed, not just heard, to captive radio audiences. In addition, it allows advertisers the ability to utilize the radio with much greater frequency, interactivity and creative value—another important aspect of “radio commerce.”

Despite the use of IBOC technology, the present invention helps streamline the process for broadcasters while also creating the opportunity for revenue generation, specifically through the process of delivering compelling digital data to a broadcaster's audience—advertising, as well as the ability to interact with a broadcast, including the purchase of goods and services. The broadcaster's audience (“consumer”) need not receive digital data through IBOC radio receivers exclusively, but will also be able to receive digital data from datacasters through other IBOC enabled devices such as handheld information devices, cellular phones, billboards and computers which have IBOC chips sets.

One embodiment of the present invention comprises a computer-based system that allows broadcasters to produce and broadcast digital data (herein referenced as “datacast”), both adjunct audio data and visually rendered data (herein referenced as “datacast elements”), which includes content, advertising, and interactivity. The system is designed to do the following:

(1) Manage and aggregate content from third party sources;

(2) Offer the ability for a broadcaster to create content for datacast over an IBOC signal;

(3) Offer the ability for a broadcaster to manage and sell visual advertising within the datacast

(4) When used specifically to augment and enhance an analog audio broadcast, regardless of programming format, monitor that broadcast and retrieve appropriate digital data to coincide with it;

(5) Permit consumers to respond to advertisements and purchase goods and services via a non-IBOC return path; and

(6) Package scheduled data in a format appropriate to dispense to an IBOC encoding device

Fundamentally, the present invention provides three key functions. First, it enhances the entertainment value of a radio broadcast by giving consumers datacast elements that enhance their radio “listening” experience through the distribution of visual components and adjunct, on-demand, digital audio components. Second, it gives broadcasters compelling reasons to convert to DAB because it provides them with an incremental revenue stream through the use of a system that is efficient, easy to use, inexpensive and requires little to no additional station resources or expense. Finally, the datacast technology is flexible, allowing the ability to support multiple receiver display capabilities thus all consumers, despite the inevitable market of receivers with varying ability, will be able to enjoy the datacast and the datacast elements.

For purposes of creating the datacast, the present invention has been designed to aggregate content from multiple providers, assign broadcast rules and parameters (herein referenced as “broadcast instructions”) to the aggregated content via web based applications, and accept sales orders for advertisements interspersed in the datacast via web based applications. Additionally, the aggregated content, advertisements, and broadcast instructions are packaged as a datacast and distributed to the appropriate station's multipurpose Internet appliance (or “black box”). The device then monitors the station's analog audio broadcast for opportunistic commercial and non-commercial availabilities within the broadcast, queues appropriate datacast elements according to those availabilities and the datacast instructions, and then interfaces with an IBOC encoding device to produce the datacast.

Thus, one embodiment of the present invention provides a method for providing data for a digital audio broadcast comprising the steps of:

(a) selecting content for the broadcast;

(b) selling advertising time for content selected;

(c) creating data for content selected and advertising time sold;

(d) aggregating content and advertising data together;

(e) transferring aggregated content and data to a remote sight; and

(f) incorporating transferred aggregate into digital audio broadcast.

Preferably this method gives the user the ability to track the selection of content, advertising time sold, and creation of advertising data. Advantageously, the method further comprises a step of receiving consumer responses to aggregate content and advertisement.

Web based software is one preferred aspect of the present invention. For example, the selection of content may be accomplished using web-based software. Similarly, one preferred method for the selling of advertising time is accomplished using web-based software. Likewise, a preferred method for the creation of data for ad time sold is accomplished using web-based software. The tracking of selection of content, advertising time sold and the creation of content may also preferably be accomplished using web-based software.

It should be noted that the present invention can include either visual content or audio content or both. For example, in one preferred aspect of this invention the broadcast is visual in nature. In another preferred aspect of the invention the ad data is visual in nature.

More particularly, the present invention provides a method for providing data for a digital audio broadcast comprising the steps of:

(a) selecting content for the broadcast in a data repository;

(b) selling advertising time for content selected in a data repository;

(c) creating data for content selected and advertising time sold in a data repository;

(d) aggregating content and advertising data together in a data repository;

(e) transferring aggregated content and data to a remote sight on a data network; and

(f) incorporating transferred aggregate into digital audio broadcast via an Internet appliance.

Advantageously, step (a) may further include the following steps:

(1) selecting the time at which the content will be broadcast;

(2) selecting the length of time the content will be broadcast;

(3) selecting the frequency of broadcast;

(4) selecting if the content will correspond to an audio portion of the digital audio broadcast;

(5) selecting the location of content on receiving device;

(6) selecting the specific station from which it will broadcast; and

(7) selecting the starting and ending dates for conducting the above steps.

Advantageously, step (b) may further include the following steps:

(1) selecting the criteria for advertisement;

(2) selecting the time at which the content will be broadcast;

(3) selecting the length of time the content will be broadcast;

(4) selecting the frequency of broadcast;

(5) selecting if the content will correspond to an audio portion of the digital audio broadcast;

(6) selecting the location of content on receiving device;

(7) selecting the specific station from which it will broadcast;

(8) selecting the unit price or cost for broadcasting data; and

(9) selecting the starting and ending dates for conducting the above steps.

Advantageously, step (c) may further include the following steps:

(1) viewing the parameters from steps (a) and (b);

(2) uploading or downloading data for creation; and

(3) complying with standards for digital audio broadcast.

Advantageously, step (f) includes the following step performed by the Internet appliance; namely, dynamically calculating Opportunistic Commercial Avails and Opportunistic Non-Commercial Avails through constant or intermittent monitoring of the audio broadcast.

Data packaging for the present invention is preferably accomplished using standardized XML schema. Transfer of aggregated content and data to a remote sight on a data network (i.e., step (e)) is preferably accomplished using HTTP/SSL communication.

Another preferred embodiment of the present invention comprises a system for providing data for a digital audio broadcast having the following integrated components:

(1) a central server where the data for the digital broadcast is compiled;

(2) a data network for transferring the compiled data; and

(3) an Internet appliance for receiving the transferred data and incorporating the data into the digital audio broadcast.

Advantageously this system provides the user with the ability to track the selection of content, advertising time sold, and creation of advertising data. In addition, this system further provides data storage for receiving consumer response to aggregate content and advertisement. Preferably, the selection of content is accomplished using web-based software. Likewise, the selling of advertising time is preferably accomplished using web-based software. In addition, the selling of creating of data for ad time sold is preferably accomplished using web-based software. Also the tracking of selection of content, advertising time sold and the creation of content is preferably accomplished using web-based software. As above, the content for the broadcast may be audio in nature, visual in nature, or both. Similarly, the advertising data may be audio in nature, visual in nature, or both.

Preferably this embodiment of the present invention further includes software and/or hardware for:

(1) selecting the time at which the content will be broadcast;

(2) selecting the length of time the content will be broadcast;

(3) selecting the frequency of the broadcast;

(4) selecting if the content will correspond to a particular audio portion of the digital audio broadcast;

(5) selecting the location of content on a receiving device;

(6) selecting the specific station from which the content will broadcast; and

(7) selecting the starting and ending dates for conducting the above steps.

More preferably, this embodiment of the invention further includes software and/or hardware for:

(1) selecting the criteria for advertisement content;

(2) selecting the time at which the content will be broadcast;

(3) selecting the length of time the content will be broadcast;

(4) selecting the frequency of the broadcast;

(5) selecting if the content will correspond to a particular audio portion of the digital audio broadcast;

(6) selecting the location of content on a receiving device;

(7) selecting the specific station from which the content will broadcast;

(8) selecting the unit price or cost for broadcasting data; and

(9) selecting the starting and ending dates for conducting the above steps.

Most preferably, this embodiment of the invention further includes software and/or hardware for:

(1) viewing the parameters from steps (a) and (b);

(2) uploading or downloading data for creation; and

(3) complying with standards for digital audio broadcast.

As above, one especially preferred embodiment of the present system is the Internet appliance or “black box,” which includes both software and hardware for monitoring the audio broadcast portion of the digital audio broadcast and dynamically calculates Opportunistic Commercial Avails and Opportunistic Non-Commercial Avails through monitoring of the analog audio broadcast.

Data packaging for this embodiment of the invention is preferably accomplished using standardized XML schema. Transfer of aggregated content and data to a remote sight on a data network is preferably accomplished using HTTP/SSL communication.

Another embodiment of the present invention is a system for providing data for use in a digital broadcast comprising the steps of:

(a) providing a central server;

(b) providing an Internet appliance;

(c) providing a data network connecting the central server and the Internet appliance;

(d) providing a device for taking orders for advertisements on broadcast on the central server;

(e) providing a device for creating data for broadcast on the central server;

(f) providing a device for aggregating data on the central server for transfer to the Internet appliance;

transferring aggregated data over data network;

(g) providing a device for receiving data transferred over data network on the Internet appliance; and

(h) providing a device for incorporating received data into an IBOC digital broadcast using the Internet appliance.

Advantageously this system gives the user the ability to track the selection of content, advertising time sold, and creation of advertising data. Preferably the system further provides data storage for receiving consumer responses to aggregate content and advertisement. Preferably the selection of content is accomplished using web-based software. Preferably the selling of advertising time is accomplished using web-based software. Preferably the selling of creating of data for ad time sold is accomplished using web-based software. Preferably the tracking of selection of content, advertising time sold and the creation of content is accomplished using web-based software.

This embodiment of the invention can include either visual content or audio content or both. For example, in one preferred aspect of this invention the broadcast is visual in nature. In another preferred aspect of the invention the ad data is visual in nature.

Preferably this embodiment of the invention further includes software and/or hardware for:

(1) selecting the time at which the content will be broadcast;

(2) selecting the length of time the content will be broadcast;

(3) selecting the frequency of broadcast;

(4) selecting if the content will correspond to a particular audio portion of the digital audio broadcast;

(5) selecting the location of content on a receiving device;

(6) selecting the specific station from which the content will broadcast; and

(7) selecting the starting and ending dates for conducting the above steps.

More preferably this embodiment of the invention further includes software and/or hardware for:

(1) selecting the criteria for advertisement;

(2) selecting the time at which the content will be broadcast;

(3) selecting the length of time the content will be broadcast;

(4) selecting the frequency of broadcast;

(5) selecting if the content will correspond to a particular audio portion of the digital audio broadcast;

(6) selecting the location of content on a receiving device;

(7) selecting the specific station from which the content will broadcast;

(8) selecting the unit price or cost for broadcasting data; and

(9) selecting the starting and ending dates for conducting the above steps.

Most preferably this embodiment of the invention further includes software and/or hardware for:

(1) viewing the parameters from steps (a) and (b);

(2) uploading or downloading data for creation; and

(3) complying with standards for digital audio broadcast.

As above, one especially preferred embodiment of the present system is the Internet appliance or “black box,” which includes both software and hardware for monitoring the audio broadcast portion of the digital audio broadcast and dynamically calculates Opportunistic Commercial Avails and Opportunistic Non-Commercial Avails through monitoring of the analog audio broadcast.

Data packaging for this embodiment of the invention is preferably accomplished using standardized XML schema. Transfer of aggregated content and data to a remote sight on a data network is preferably accomplished using HTTP/SSL communication.

Another embodiment of the present invention entails a system for providing data on an in-band, on-channel (IBOC) FM digital audio broadcast comprising:

(a) hardware and/or software under control of a client system and providing:

(1) means for requesting content;

(2) means for requesting advertising;

(3) means for creating data; and

(4) means for monitoring the requests and data creation;

(b) hardware and/or software under control of a server system and providing:

(1) means for receiving requests;

(2) means for storing data;

(3) means for aggregating data for transfer;

(c) hardware and/or software under control of an Internet appliance in communication with parts (a) and (b) defined above, and further providing:

(1) means for receiving transferred aggregate data, and

(2) means for incorporating data into broadcast.

Preferably this embodiment of the invention provides the user with the ability to track the selection of content, advertising time sold, and creation of advertising data.

Preferably this embodiment of the invention further includes data storage for receiving consumer response to aggregate content and advertisement.

Preferably this embodiment of the invention uses web-based software for selection of content. Preferably this embodiment of the invention uses web-based software for the selling of advertising time. Preferably this embodiment of the invention uses web-based software for the selling of creating of data for ad time sold. Preferably this embodiment of the invention uses web-based software for the tracking of selection of content, advertising time sold and the creation of content.

This embodiment of the invention can include either visual content or audio content or both. For example, in one preferred aspect of this invention the broadcast is visual in nature. In another preferred aspect of the invention the ad data is visual in nature.

Preferably, this embodiment of the invention further includes software and/or hardware for:

(1) selecting the time at which the content will be broadcast;

(2) selecting the length of time the content will be broadcast;

(3) selecting the frequency of broadcast;

(4) selecting if the content will correspond to an particular audio portion of the digital audio broadcast;

(5) selecting the location of the content on a receiving device;

(6) selecting the specific station from which the content will broadcast; and

(7) selecting the starting and ending dates for conducting the above steps.

More preferably, this embodiment of the invention further includes software and/or hardware for:

(1) selecting the criteria for advertisement;

(2) selecting the time at which the content will be broadcast;

(3) selecting the length of time the content will be broadcast;

(4) selecting the frequency of the broadcast;

(5) selecting if the content will correspond to a particular audio portion of the digital audio broadcast;

(6) selecting the location of the content on a receiving device;

(7) selecting the specific station from which the content will broadcast;

(8) selecting the unit price or cost for broadcasting data; and

(9) selecting the starting and ending dates for conducting the above steps.

Most preferably, this embodiment of the invention further includes software and/or hardware for:

(1) viewing the parameters from steps (a) and (b);

(2) uploading or downloading data for creation; and

(3) complying with standards for digital audio broadcast.

As above, one especially preferred embodiment of the present system is the Internet appliance or “black box,” which includes both software and hardware for monitoring the audio broadcast portion of the digital audio broadcast and dynamically calculates Opportunistic Commercial Avails and Opportunistic Non-Commercial Avails through monitoring of the analog audio broadcast.

Data packaging for this embodiment of the invention is preferably accomplished using standardized XML schema. Transfer of aggregated content and data to a remote sight on a data network is preferably accomplished using HITP/SSL communication.

Another preferred embodiment of the present invention comprises a system for datacast advertisement strategic placement. This system uses hardware and software to utilize market research to enable the user to efficiently and effectively target specific demographic audiences with their datacast advertisements within the Impulse Radio network of datacasters. Users will select specific target audiences based upon standard market research and the system will be programmed to send datacast advertisements to targeted audiences.

Another preferred embodiment of the present invention comprises the process by which the Internet appliance calculates opportunistic commercial avails and opportunistic non-commercial avails for the purposes of inserting appropriate datacast elements into the datacast. This process comprises the steps of:

(a) dynamically monitoring of the audio broadcast by the Internet appliance;

(b) calculating the presence of one or more opportunistic commercial avails and one or more opportunistic non-commercial avails; and

(c) inserting appropriate datacast elements into the datacast based upon said calculations.

Another preferred embodiment of the present invention is a method for the processing of transactions between the datacast consumer and the data displayed or heard on the IBOC receiver device, comprising the following steps:

(1) maintaining inventory codes that can be applied to and later identify all transactionable datacast elements;

(2) defining actions that can be performed for all transactionable datacast elements;

(3) assigning actions to every transactionable datacast element;

(4) providing a transaction gateway that listens for a consumer's transaction request from any return path;

(5) providing one or more transaction engines that perform the appropriate action for that datacast element and confirms completion of the action for the consumer; and

(6) providing a consumer-centric commerce web site where consumers can setup accounts, gathering all necessary information for the completion of the transaction.

Completion of the transaction by the consumer would normally include the consumer providing specific information, including the following; Name, E-mail address, physical address, credit card information and any other important information.

### BRIEF DESCRIPTION OF THE DRAWINGS

FIGS. 1 and 2 give an overview of the entire data-casting and rCommerce network.

FIG. 3 illustrates a schema used to organize the datacast elements to meet the varying needs of the system in accordance with the present invention.

FIG. 4 shows the repository and how different embodiments interact with it.

FIG. 5 illustrates “agents” that aggregate data and place it in the repository.

FIG. 6 illustrates how data is moved between devices in the network.

FIG. 7 illustrates how data is inserted into a broadcast.

### DETAILED DESCRIPTION OF THE PREFERRED EMBODIMENTS

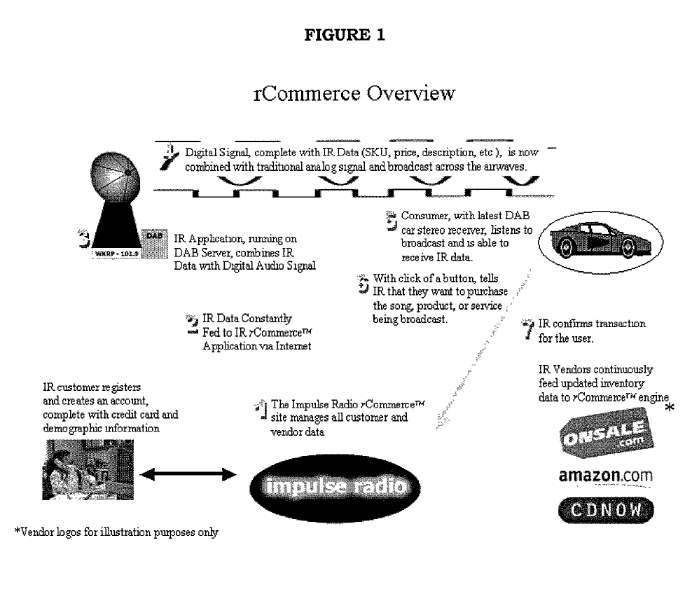

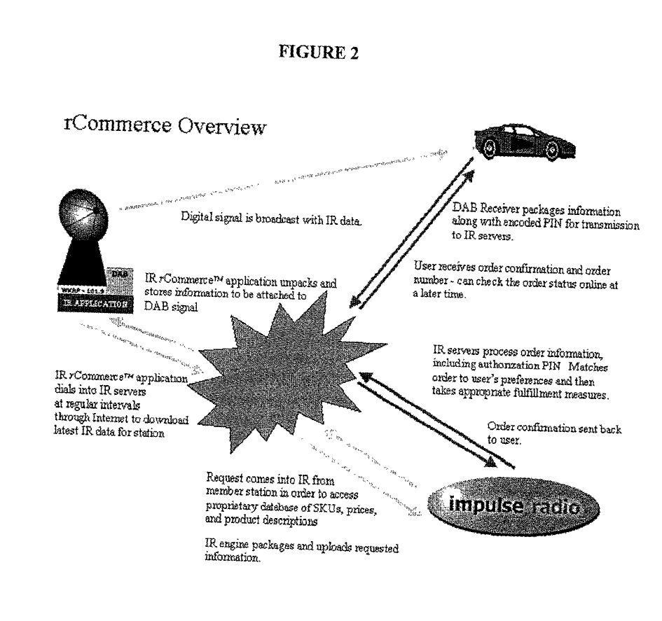

As shown in FIGS. 1 and 2, the present invention embodies a series of sub-systems that allow broadcasters to produce an entertaining and interactive flow of data for a multitude of purposes. Data moves from a variety of sources through a central point where it is formatted for broadcast and assigned certain instructions that trigger its broadcast and associate actions with it. For example, information can be supplied, either visually or audibly, that would facilitate a purchase by the listener. This can range from the pure informational, such as the name of an artist and a song that has been broadcast, to the interactive where the listener conducts a transaction based upon the information in the broadcast. The data is then transferred to a radio station or other broadcast facility where it is combined with the digital audio and inserted into the broadcast. A device that is capable of interpreting the IBOC signal renders the data and audio based upon the presentation characteristics assigned to it. Encoded information from the data-cast can be transmitted to a system or systems that can engage a transaction on the listeners or broadcasters behalf. These sub-systems will now be described in detail. Where appropriate, embodiments are accompanied with a figure that illustrates its activity.

Digital Data:

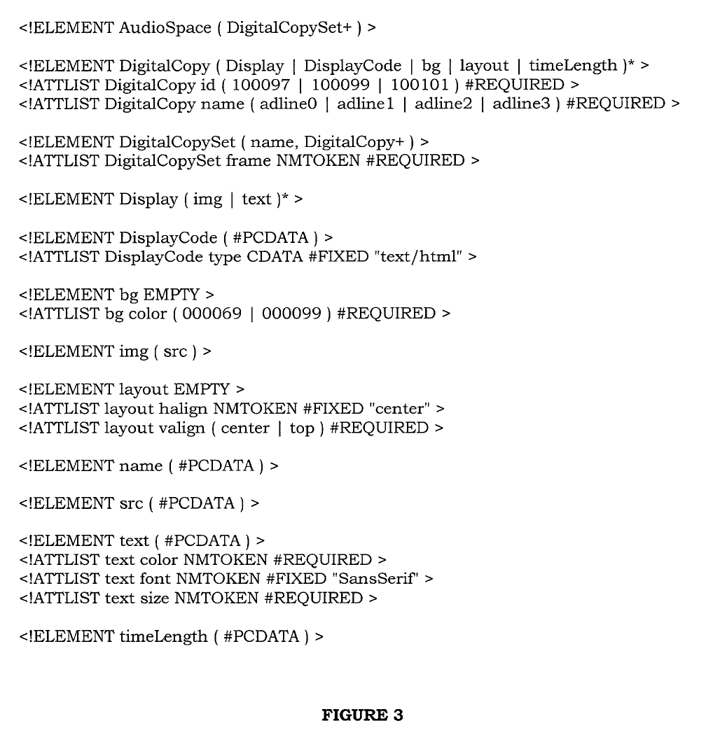

Certain embodiments of the current invention provide a schematic (“schema”) for defining digital data (“data”). An example of such a schema is given in FIG. 3. The schema divides the data into data that is rendered and data that provide instructions for presentation and associated actions.

The data can be both related to digital audio data (“audio”) or independent of the analog broadcast. The concepts of related and independent do not signify a physical relationship between the analog audio broadcast and the data-cast element, but rather, they describe the nature of the content of the data-cast element in relation to the analog audio broadcast. Related portions of the data generally contain content that further describes or enhances the audio, although they need not. Related data-cast elements are triggered, and thus data-cast, based upon criteria of the audio. For instance, data may be triggered because of the audio “cut” id that identifies the audio in the broadcasters library. In this case, a cut refers to a single element from a radio station library such as a song, commercial, weather report, etc. In another instance the data may be triggered because the cut belongs to a classification of cuts, such as music, or news.

Independent data-cast elements provide a complete set of information in and of themselves and do not have to be directly associated to a cut. The association of independent data can be much broader and may be based upon any current radio programming parameter such as time, day part, program, competitive content spacing, etc. These associations may also be based upon new radio programming parameters as embodiments of the invention define. For example, these parameters can include the location on an LCD display connected to a receiver device, or instructions that require users interact with the receiver device before the data is rendered.

Certain embodiments define characteristics of the rendered portion of the data. For example, these characteristics can include competitive separation of different data-cast elements, color, layout, font, size, location and other physical indications. Other embodiments define characteristics for the data to identify the actions associated with a piece of data that would enable a listener to engage in a commerce activity. These characteristics can include information that identifies the object described by the data, the nature of the transaction, and the identity of the listener.

Further embodiments related to a data-cast provide a methodology and a system for packaging the data and the audio for broadcast on an IBOC signal. This provides a physical relationship between data and audio. This relationship can be described by characteristics such as the length of time a piece of data should play for and the time in relation to the audio when a piece of data should play. They can also describe the length of time a piece of data should live for on the receiver device before it is removed.

Data Repository:

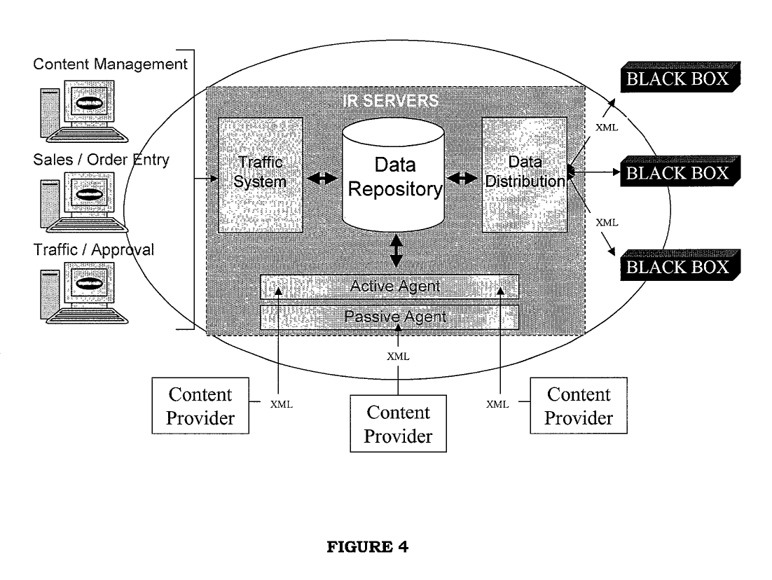

The invention embodies a data repository where all data is stored such that it can be accessed by any broadcaster in the network. The repository defines the methodology and the system of storage for all types of data as well as a system for moving data in and out of the repository. FIG. 4 provides an illustration of this.

Content Management:

An embodiment of the invention provides a system that allows a broadcaster to establish a set of broadcast rules for various groups of data and store them in the repository. These rules can include such elements as the timing, flow and occurrence of the data during the broadcast, as well as the identity of the broadcast facility that will perform the broadcast. For example, a broadcaster might desire to schedule constantly updated traffic reports to be data-cast at regular intervals during particular times of the broadcast day. These parameters can include the time at which the data should be broadcast, the length of time it should be broadcast for, and the frequency with which it should be broadcast. Other parameters can make associations with the audio such as whether or not it will be broadcast in conjunction with a specific audio cut. The data can also be characterized to signal instructions to the device that renders the data as to proper formatting and presentation elements.

Ad Placement:

Another embodiment provides a methodology and a system that enables the broadcaster to schedule data that is intended as an advertisement and insert it into the repository. The embodiment provides a means for broadcasters to schedule the data, as well as audit the broadcasting of the data. They can also track the financial aspects of the data, such as the price and number of times the data is broadcast. This information is inserted into the central repository. The embodiment also provides a means for a broadcaster to have a single piece of content and its associated parameters apply to a multitude of broadcast facilities. Schedule parameters include but are not limited to the starting and ending dates for the advertisement to be broadcast, the frequency with which the advertisement will be broadcast, the time at which the advertisement will be broadcast Other parameters can make associations with the audio such as whether or not it will be broadcast in conjunction with a specific audio cut. The data can be characterized to signal instructions to the device that renders the data with proper formatting and presentation elements.

Traffic Management:

The invention embodies a methodology and a system for coordinating advertisements and content within a data-cast using the information in the repository. This can be used to ensure the continuity of the broadcast by providing a process by which broadcasters can control the flow of data through the network, from its source to the devices responsible for the data-cast. The embodiment performs functions such as preventing data, be it content or advertisement, from being scheduled beyond the capacity of the broadcast day. It also provides information to broadcasters regarding the level of data already scheduled for a particular broadcast day. Additional information supplied by the embodiment includes production information for data. For example, an ad may have been scheduled but no data has been produced for it yet. Data can be prevented from being broadcast until it has all of the information required to properly broadcast the data and the broadcaster signifies as such.

Data Aggregation:

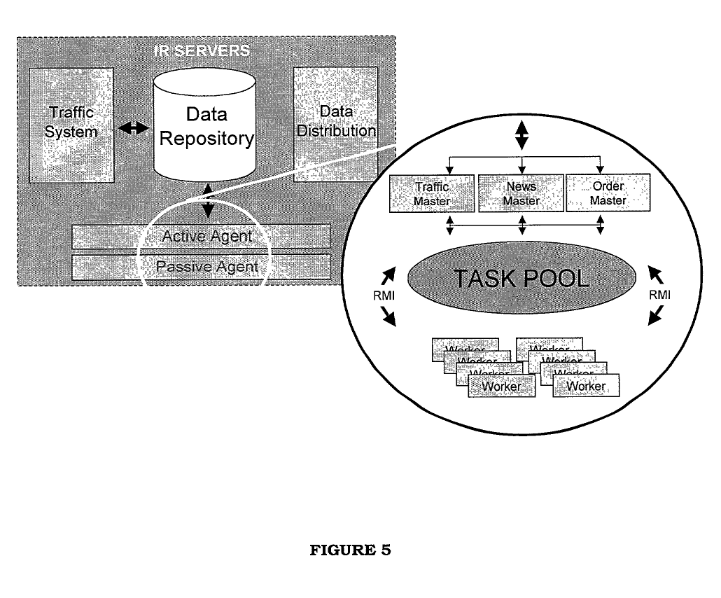

The invention embodies a methodology and a system for aggregating content from a multitude of sources and inserting them in the data repository for use in a data-cast. An illustration of this is given in FIG. 5. The embodiment defines a standard architecture for data aggregators, referred to as “agents,” designed to perform the function of collaborating with third party content vendors to collect content, format it, and store it in the data repository. The embodiment defines a unique agent for each content supplier that follows the standard architecture of the agent definition. Additionally, the embodiment provides a way to classify and identify the data. This gives broadcasters the ability to associate data with schedules. For example data can be classified as traffic data and be identified as a particular provider of traffic data for a particular geographical region and can thus be associated with data schedules for all broadcast facilities broadcasting that traffic data for that region. In another example, data can be classified as an ad and allow broadcasters to associate it with an ad placement schedule.

Data Transfer:

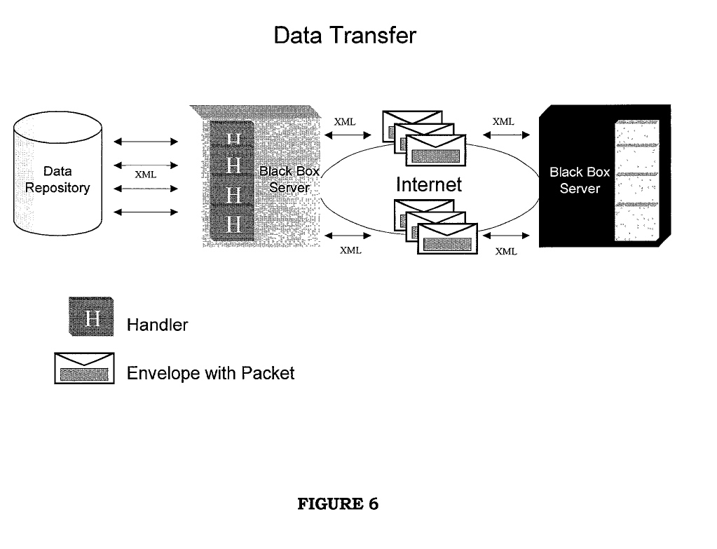

Certain embodiments of the invention provide a methodology and a system for moving data throughout the network. The embodiment defines and implements a transaction framework for all communication within the network that is capable of conducting multiple “atomic” transactions over a single request via a wide area network. An illustration of this is given in FIG. 6. Typically the communication is between devices that control the data-cast from inside a broadcast facility and the data repository. The embodiment is used to move all of the appropriate data for a particular broadcast facility from the repository to the facility on a continual basis as it is needed for broadcast, while ensuring its proper delivery and recovery from error.

Data-Casting:

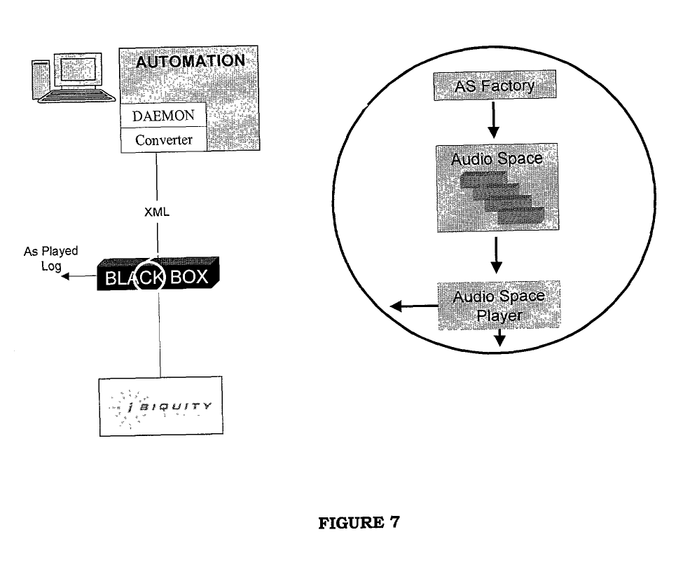

The invention embodies a methodology and a system as well as a configuration for a multipurpose device that interfaces with the broadcast systems within a broadcast facility to perform data-casting functions. An illustration of this is given in FIG. 7. Activities of the embodiment include performing algorithms to calculate commercial availabilities and non-commercial availabilities for the packaging and insertion of data and audio for the data-cast. Opportunistic commercial or non-commercial availabilities (“avails”) occur when it is determined, through monitoring the activity of broadcast facility's audio broadcast, that an opportunity to insert data along with the audio occurs. The device that houses the embodiment should be able to communicate with systems inside a broadcast facility, including IBOC transmission devices and broadcast automation or live assist systems, as well as have access to the data repository. It should have a permanent storage device, a CPU, and a display that indicates the status of the device.

Certain aspects of the embodiments monitor activity regarding the available bandwidth for data within the IBOC system. This information is used to make determinations such as the quantity of data that can be added to the audio in order to achieve an acceptable level of service. For example, the data may consist of images and text; however, the current bandwidth available for sending data would only allow text to be transmitted to the receiver in time for display. The system could choose to send only the text and omit the image rather than have no data transmitted.

Data Creation:

Another embodiment of the invention provides a methodology and a system for creating data. It provides a way to create data that is to be broadcast in concert with the audio, whether it is dependent or independent. Data creation requires collecting objects such as images, text, audio, and other media and organizing them in terms of order, positioning, and timing. It also deals with the assignment of formatting parameters such as colors and size. Furthermore, it can correlate an object's behavior with the behavior of the audio.

Strategic Ad Placement:

Certain embodiments of the invention provide a methodology and a system for defining and matching audience criteria of broadcast facilities in the network against desired audience criteria of an advertiser. This matching process can produce a suggestive list as to the broadcast facilities that are optimal for broadcasting the data. The system can use this information to automate the scheduling process. For example, a national advertiser may want to reach all males between the ages of 25-34 with a household income of $35,000 or more. The embodiment can indicate the broadcast facilities within the network whose audience has the greatest population or concentration of the desired target.

Radio Commerce (“rCommerce”):

The invention embodies a methodology and a system that provides a way data from a broadcast can be routed via a Wide Area Network in order to perform an action (or transaction) on behalf of a broadcaster or a listener. This data transmission could also be provided by devices such as a WAP device or a PC.

The embodiment defines the required data for the transaction. This can include information that identifies the listener, information that identifies the broadcaster, information about the data that was being rendered that led to the action, information regarding the action that the listener desired to be performed, as well as network routing information.

rCommerce Gateway:

Certain embodiments of the invention provide a methodology for receiving data that was originated from a broadcast in order to conduct a transaction. The embodiment performs such functions as listening for requests from IBOC devices or devices communicating with IBOC devices, performing validation on the data received, performing or initiating the action indicated by the data, and responding to the device sending the request.

As illustrated in the Figures, the key components of the system thus include: Central Servers, Datacast Applications, Content Management Applications, Sales/Order Entry Applications, Traffic/Approval Applications, Content Creation, Data Aggregation, Data Transfer, and the multipurpose Internet appliance or “black box” device. Software for implementing the methods of the present invention may take any form available to the programmer having ordinary skill in the art. The methods having been described herein may be implemented via any number software solutions.

Central Servers:

The Central Servers act as the back end of the sales order entry, traffic, and content aggregation systems. The Central Servers are able to perform content aggregation from multiple providers, which can be customized for individual radio stations for purposes of a datacast. Additionally, they provide the communication architecture for the nationwide network of black boxes housed in radio stations while supplying the storage facility (herein referenced as “the data repository”) for all digital data and datacast elements.

Content Management Applications:

Central to the technology's Datacast Applications is the Content Management system, which is web-based software that allows a user to select from customizable content packages stored in the data repository. The software functionality allows the datacaster to control timing, flow and occurrence of datacast elements such as weather reports, news headlines, traffic alerts, etc. For example, a Program Director could schedule constantly updated traffic reports to visually appear every 15 minutes during morning and evening drive time. Via the application a user defines the datacast element and stores scheduling parameters for it on the system of the present invention's Central Servers. These parameters include but are not limited to the following:

(1) the time at which the datacast element will be broadcast (datacast);

(2) the length of time it will be broadcast (datacast);

(3) the frequency with which it will be broadcast (datacast);

(4) whether or not it will be broadcast (datacast) in conjunction with a specific audio component of the analog broadcast;

(5) the position or location on an IBOC signal receiving device where the datacast element is to be placed;

(6) the specific station(s) from which it will be broadcast (datacast); and

(7) the starting and ending dates for the above parameters (if applicable)

Sales Order Applications:

Another critical Datacast Application component is the Sales Order Entry System (herein referenced as the “Datacast SOES”). It allows a user to enter and manage detailed orders for the sale of advertising space during the datacast using an intuitive web based interface. By entering an order in the system, a user defines specific parameters on the system of the present invention's Central Servers pertaining to how the order will “fit” into the datacast. These parameters include but are not limited to the following:

(1) The starting and ending dates for the advertisement to be datacast;

(2) The frequency with which the advertisement will be datacast;

(3) The time(s) at which the advertisement will be datacast;

(4) Whether or not the advertisement will occur during the datacast in conjunction with a specific audio component of the analog broadcast;

(5) The unit price or otherwise defined cost for advertisement;

(6) The stations from which the advertisement will be datacast;

(7) The length of time for which the advertisement will be datacast; and

(8) The location or position of the advertisement in an IBOC signal receiving device.

Data Creation Applications:

A critical step towards the procurement of advertising revenue from advertisements inserted in the datacast is the creation of those advertisements. To that end, the present invention provides web based software for the creation of datacast advertisements—regardless of whether the advertisement is delivered via adjunct digital audio or through visual components that are meant to be either related to or independent of the audio component of the analog broadcast. The Data Creation Application works in concert with other applications, specifically the Datacast SOES where procedures exist for salespeople to enter instructions in the sales order for the procurement or production of the datacast advertisements used in that order. These instructions (part of the entire sales order) are stored in the data repository on the system of the present invention's Central Servers. The Data Creation Application enables a user, typically an advertising professional or one skilled in the development of advertising media, to log into the Central Servers and:

(1) View the datacast advertisement instructions mentioned above (saved via the sales order application.), which may include one or more of the following guidelines:

a. Size of the datacast advertisement

b. Length of the datacast advertisement

c. Position and Location in an IBOC signal receiving device intended for the datacast advertisement

d. Location or description of acceptable images for the conveyance of the proper message

e. Location or description of acceptable copy for the conveyance of the proper message

f. Location of audio clip for which this datacast advertisement is meant to accompany, if applicable

g. Due date for the datacast advertisement

h. Uploading instructions

(2) Create the datacast advertisement in compliance with digital data IBOC broadcast standards, including the following tools:

a. Text editor, for the purposes of creating new text elements or editing existing ones

b. Image editor, for the purposes of creating new image elements or editing existing ones

c. Audio editor, for the purposes of synchronizing visual components to an audio clip, creating new digital audio elements, or editing existing ones

d. Library of Formatting Instructions for text, images and digital audio elements

e. Library of Formatting Instructions for layout and presentation of the datacast advertisement

(3) Upload the completed datacast advertisement to the data repository so that the sales order can be completed and the datacast advertisement is sent to the appropriate black boxes for datacast.

Traffic Management Application:

The coordination of datacast advertisements with other datacast advertisements, audio advertisements and programming on the analog broadcast, and the entire datacast itself (which is often coordinated with the entire analog broadcast) demands an enormous amount of information management. Thus the present invention provides a Traffic Management Application (herein referenced as the “Datacast TMA”) for this purpose. This application allows users to track datacast advertisement sales orders saved on the central servers, track datacast advertisement production progress, utilize permissions-based editing of the aforementioned sales order parameters and approve sales orders for datacast.

Data Aggregation:

Providing content, aggregated from third party sources, to broadcasters for the purpose of developing a datacast is a vital element of the invention. Therefore, the invention produced standard architecture for data aggregation “agents,” or software applications designed to perform the grunt work of collaborating with third party content vendors to collect their content and store it in the data repository of the invention's Central Servers. There are unique agents for each content type and vendor, though all agents follow the standard architecture.

Data Transfer:

The system of the present invention's technology also provides standardized architecture for digital data packaging. Additionally, it provides a transaction framework for all Black Box communication with the invention's Central Servers, using HTTP/SSL communication, that is capable of conducting multiple “atomic” transactions over a single request.

Multipurpose Internet Appliance (or “Black Box” Device):

The system of the present invention further comprises a multipurpose Internet appliance (or “black box” as shown in the Figures), which resides within each individual radio station to perform a multitude of actions necessary for a successful datacast. The primary function of the black box is to prepare datacast elements in a manner that constitutes a datacast and then interface with an IBOC encoding device to dispense that datacast. Specifically the black box performs the following tasks:

(1) Communicates with central servers to request datacast elements necessary to build the datacast;

(2) Performs algorithms on an analog audio broadcast, when applicable, to calculate commercial availabilities and noncommercial availabilities for the insertion of datacast elements into the datacast;

(3) Packages appropriate datacast element for inclusion in the datacast based on parameters saved on central servers and passed along to the black box;

(4) Interfaces with and delivers datacast to an IBOC transmission device.

Digital Data:

The primary aspect of the invention is to enable radio broadcasters to transmit digital data, be they visual or auditory, that can be both related to the current analog broadcast or independent of the analog broadcast. The concepts of related and independent do not signify a physical relationship between the analog audio broadcast and the datacast element, but rather, they describe the nature of the content of the datacast element in relation to the analog audio broadcast. Related portions of the datacast element generally contain content that further describes or enhances the analog audio, although they need not. Related datacast elements are triggered, and thus datacast, with the identification of the analog audio “cut”. In this case, a cut refers to a single element from a radio station library such as a song, commercial, weather report, etc.

Independent datacast elements provide a complete set of information in and of themselves and do not have to be directly associated to a cut. The association of independent data can be much broader and may be based upon any current radio programming parameter such as time, day part, program, cut, competitive content spacing, etc. These associations are defined by users of the Datacast SOES and Datacast TMA when they enter the sales order for the datacast element, but are also defined by specific information being culled by the black box from the analog audio broadcast such as the length of the current cut, the time of day, and other such broadcast information.

Some datacast elements are rendered visually, in concert with the analog audio broadcast (“visual datacast elements”). Other datacast elements are rendered audibly and are available to be played by the user on the IBOC signal receiving device for a period of time at certain intervals as defined by the rules of the Datacast SOES and Datacast TMA on request (“audio datacast elements”). These datacast elements can be used, by themselves or in conjunction with each other, to create an entirely new radio experience for the consumer—one that can be complementary to the analog broadcast or completely independent to the analog broadcast—or in lieu of the analog broadcast altogether.

Thus, one embodiment of the current invention provides a schematic (“schema”) for datacast elements. An exemplary rendition of such a schema is given in FIG. 3. The schema organizes the datacast element to meet the varying needs of the system. The datacast element can be divided into what is termed “rendered data” and “meta-data”. The rendered data are data that are either viewed or heard by the user. This would be the title of a song, the artist singing the song, an audio weather report, etc. The meta-data are considered to be “data about the data” and are used to indicate formatting and timing directives.

Formatting and timing directives are used by the IBOC encoding device and the IBOC signal receiver to render the data in a fashion that meets the goal of producing the desired datacast effect, enable user interaction and ultimately, commerce transactions. These directives include the length a portion of a datacast element should play for, separation of different datacast elements, order of appearance, color, layout, and other physical indications as well as codes to identify the datacast's consumer as well as the item described by the datacast element—pieces of data vital to conducting radio commerce transactions as outlined in the section entitled “Radio Commerce.”

Sales Orders & Traffic Management:

In a typical revenue-generating analog radio station, revenue is derived from the placement of advertisements in the audio broadcast or sponsorships of specific times or events during the broadcast.

For those advertisements to exist, radio stations employ the services of salespeople to proactively seek and sell new clients as well as handle the processing of sales orders from existing clients and other known entities that place advertising media (i.e., media buying services, ad agencies, etc.). Salespeople enter advertisements into the radio station's broadcast through a Sales Order Entry System (“SOES”), which often specifies the client, billing address, advertisement to be broadcast, as well as other necessary information for the fulfillment of the advertisement, where fulfillment is defined as the successful broadcast of the client's advertisement during the time the client requested. When the advertisement to be broadcast is not “in-hand” meaning that it either does not currently exist or is in another location, instructions are gathered for the procurement or production of the advertisement.

Accordingly, the people responsible for the running of that radio station (herein “station manager”), set parameters to effectively distribute all advertisements throughout the station's broadcast. A station's content is typically music that correlates to a specific format, but can also be talk radio shows (i.e., “Mike and the Mad Dog”), syndicated programs (i.e., “The Howard Stern Show,” “Dr. Laura,” etc.), or live entertainment (i.e., concerts, sporting events, etc.). These parameters are typically stored in software that is often referred to as a Traffic System (herein referenced as “TS”)—Marketron and CBSI are recognized brands of this type of software. Parameters can and do include industry accepted factors such as competitive codes, rates, make-good instructions, production notes (if the advertisement is to be produced by “inhouse” talent or production staff), and other known factors.

A Traffic Manager is the person at a station who is responsible for the management of these advertisement parameters, as well as the approval of sales orders entered into the system and the affidavits that advertisements were in fact broadcast at the appropriate times. The affidavits are used for accounting purposes so the station can charge for the “air time” (the specific avail when the advertisement was broadcast) during which the ad ran. In the event an advertisement was not broadcast when it was scheduled to, due to time constraints or other reasons, a make-good is performed. A make-good usually consists of the station deferring payment for the advertisement until that advertisement has run appropriately, or performing some other agreed upon act (like additional free advertisement placements, etc.) to make up for the missed advertisement.

Affidavits can only be created after the Traffic Manager has received a log of the most recent broadcast, commonly referred to as an As Played Log (“APL”). The APL details every piece of station content and advertisement actually broadcast over the air-waves. The APL is then compared to the schedule of what was supposed to play, thereby identifying which advertisements and pieces of station content WERE NOT broadcast, initiating a possible make-good situation.

Advertisements are produced in a variety of manners, but all have an audio component that is supposed to relay some message to the intended consumer. Typically, these advertisements incorporate jingles or music to add as a background supplement to the actor's voice. Other times, sound effects are added to emphasize the action in the advertisement or the message that is trying to be conveyed. The advertisements are typically produced by professionals at an Advertising Agency or by production teams at a radio station. These advertisements are then delivered to the radio station by means of audio tapes, carts, or digital transmission over satellite. Once received by the radio station, the advertisements are stored for broadcast at a later time—and they can be stored on a data storage device, such as a hard drive, or left on the medium in which they arrived.

Station Content:

In an effort to entertain and inform their audience, as well as maximize the effectiveness of their clients' advertisements, a radio station provides programming content (“Station Content”) for the station's listeners, which can range from regular traffic and weather updates to various news reports throughout the day. Stations typically pay third party providers (i.e., Shadow Traffic, AccuWeather, Associated Press, etc.) for this station content and must develop procedures for aggregating and managing it themselves. Besides providing informative or entertaining content, these station content snippets provide opportunities for the placement of advertisements immediately before or after (and sometimes during) they are broadcast. This is commonly referred to in the radio industry as “adjacencies.” Advertisers are attracted to adjacency Avails because they are, by definition, next to the valuable content being broadcast.

Accordingly, some datacast elements, such as those packaged from aggregated third party content providers, will serve a similar role in the datacast as Station Content does in the analog audio broadcast. These datacast elements include weather data, traffic data, news data, sports data, etc. and are provided to the broadcaster by Impulse Radio through the system of the invention. Other examples include datacast elements that visually represent Artist information, album cover pictures, station jockey pictures, address information, and other informative or entertaining content. And like their analog broadcast counterparts, these informative or entertaining datacast elements also produce avails—opportunities to deliver advertising immediately before, after and in some cases during the datacast element. The Datacast SOES and Datacast TMA are cognizant of these avails and a user can create sales orders for a client that attempt to take advantage of them.

In addition to these datacast elements, the invention also provides a Data Creation Application for the development of datacast elements that serve as advertisements in the datacast (in this specific instance of a datacast element as an advertisement, it is referred to as a “datacast advertisement”). Datacast advertisements can be visual—as simple as a line of text displaying a company's tagline or as complex as an animated video clip, much like a commercial one might see on television. As explained earlier, these new visual datacast advertisements must have the capability to relate to the audio that is being broadcast (“Related Datacast Advertisement” or “RDAs”), thereby enhancing the analog audio broadcast with a visual component, or be independent of the audio that is being broadcast (“Independent Datacast Advertisements” or “IDAs”), thus delivering an entirely new and different message from the one being broadcast.

In the traditional broadcast environment, a radio station might wish to make money from the broadcast a mattress company's advertisement. The sales order calls for a 30 second advertisement that incorporates background music and a professional actor's voice to deliver the message of their high quality, low-cost beds. That advertisement can only be broadcast when the Traffic Manager uses Trafficking Software to schedule it in an Avail in the programming schedule. The Trafficking Software makes the decision as to where to place the ad based on analysis of competitive codes and other parameters—the Traffic Manager tacitly or explicitly approves this decision. The radio station only makes money when this advertisement is played. By the linear nature of analog audio broadcasts and the rules that regulate programming content, stations obviously cannot generate revenue when advertisements are not playing.

However, the ability to transmit digital data alongside the analog audio broadcast and the system of the present invention's system changes that limitation. Through the use of the present invention's system, a broadcaster could schedule advertising for each minute of every broadcast hour by creating datacast advertisements (audio or visual) to be datacast throughout the entire analog audio broadcast. Whether the broadcaster does in fact fill every minute of every broadcast hour with advertising is determined by the limits of the procedures and decisions that govern their business.

Going back to our example, a broadcaster might entice the mattress company to create a RDA or an IDA for datacast. In fact, a single datacast advertisement can serve both roles (as an IDA or RDA) depending on when the datacast advertisement is scheduled to play. For example, a datacast advertisement is created for the mattress company that is 30 seconds in length. It incorporates many of the same messages heard in the analog audio ad, but now the copy spoken by the professional actor is in the form of text, formatted by font or color for better brand association. The datacast advertisement also has a picture of the mattress company's top three selling mattresses, as well as a picture of the company's President. Finally, the phone number and address are displayed near the end of the 30-second datacast advertisement. For a variety of reasons, the mattress company wants to display this datacast advertisement whenever their analog audio advertisement is NOT playing over the airwaves.

In this scenario, the datacast advertisement is an Independent Datacast Advertisement (IDA), since theoretically the DJ could be announcing the latest weather report while the mattress company's datacast advertisement is being displayed. However, the mattress company may have designed this datacast advertisement specifically for the purpose of enhancing the analog audio ad mentioned above and wants it to play ONLY when that audio advertisement IS broadcast, thus making that same datacast advertisement a Related Datacast Advertisement (RDA). Of course, the mattress company may develop separate and multiple datacast advertisements for each purpose. The key for the IBOC broadcaster is that, with datacast advertisements, he is able to generate revenue even while non-commercial programming is being played on the analog broadcast.

Opportunistic Commercial and Non-Commercial Avails:

Opportunistic Commercial Avails (“OCAs”) occur when the black box has determined, through the constant monitoring of the station's analog audio broadcast, there is an opportunity to insert specific datacast elements into the datacast. There is a visual component to the radio broadcast brought about from the data that is transmitted over IBOC technology.

Datacast Advertisement Strategic Placement Application:

Advantageously, the system of the invention also allows national advertisers to target specific demographic audiences throughout the integrated network of IBOC broadcasters for the efficient and intelligent placement of their datacast advertisements. For example, a national advertiser may want to reach all males between the ages of 25-34 with a household income of more than $75,000. Using our Strategic Placement Application, the advertiser can target those stations within our network that deliver that demographic audience and place their datacast advertisements ONLY in those stations.

Data Creation Application:

The invention embodies a Data Creation Application (“DCA”). This tool helps an advertising professional (“AP”), or other person skilled in the practice of developing advertising media, develop engaging datacast advertisements in accordance with the most popular concepts for advertising creation tools already in practice. These concepts include the use of images for backgrounds and key visuals, text which can be formatted appropriately for proper brand identification according to font size, style and color, as well as various visual effects such as animation, wipes, fades, etc. The DCA also contains an audio editing mechanism that enables the AP to load audio clips into the creation software and then playback that audio when necessary. It also enables the AP to create datacast advertisements that are entirely auditory in nature. The DCA allows the AP to create images with the software or import pre-existing images or images made with other imaging software products. The DCA was designed with the intention to allow users to create Related Datacast Advertisements as well as Independent Datacast Advertisements.

With IDAs, the AP decides (within a pre-defined set of allowable lengths) the length that the new datacast advertisement is supposed to be. The DCA then creates a “timeline” where 0 is the starting point and the end unit of the specified length is the ending point. If the datacast advertisement is visual in nature, all the visual components (that are meant to be viewed) must take place between these two points. Using the DCA, the AP is then able to insert whatever text, image, or combinations thereof are to be displayed for that particular datacast advertisement inside the timeline. When the AP has reached a stopping point, the datacast advertisement can be saved and stored for later editing. If the AP achieves the desired effect, the datacast advertisement is finalized.

With RDAs, the datacast advertisement is designed to coincide or enhance the audio that is simultaneously being broadcast on the analog side. Accordingly, the AP is able to load the particular analog audio clip meant for this datacast advertisement into the DCA using the audio editor. Once loaded, the DCA calculates the ending point of the datacast advertisement based on the length of the audio clip. Then, as with IDAs, the AP is able to create a series of text, images, adjunct digital audio and/or combinations in an attempt to deliver a compelling enhancement to the audio clip that will be broadcast. These datacast advertisements can also be saved and stored for additional editing at a later time or finalized.

Once finalized, the DCA converts the datacast advertisement into a format that is understood by the system of the present invention. When appropriate, the AP can upload datacast advertisements to the present invention's data repository so that they can be associated with waiting sales orders or placed in a separate staging area where they can wait until selected by a Sales Rep or Traffic Manager when placing a Sales Order.

In order for any of these datacast advertisements to be displayed on IBOC receivers, sales orders must be entered into the system of the present invention system using the Datacast SOES. This follows the same model as found with audio advertisements in a traditional radio station.

Each station's sales force is not responsible for the full inventory of their station's datacast Avails. Per its agreement with the an outside agency (e.g., Impulse Radio) using the system of the present invention, each radio station will have bartered a percentage of that inventory in exchange for the full suite of the system of the present invention's services, including the Datacast SOES, the Datacast TS, the DCA, and all datacast content packages. That inventory bartered to Impulse Radio thus becomes part of the network of radio stations throughout the country where it is able to insert datacast advertisements for its client base of national advertisers. The network has been designed to offer the system of the present invention and its advertising clients maximize flexibility and reach, while eliminating unnecessary competition with member radio stations and their sales efforts. The radio station focuses on its existing local client base while the system of the present invention taps a heretofore unrealized national advertising base. The network and this process are described in greater detail in the section entitled “Datacast Advertisement Strategic Placement Application.”

The Datacast SOES is designed to help each station's sales force identify their datacast avail inventory (after excluding the system of the present invention's percentage) and provide a seamless method to enter sales orders for those avails in an effort to maximize the sales process. The salesperson enters into a sales contract with a new or existing client and enters all appropriate information into the Datacast SOES, including the client's name and billing address, the specific product being promoted, the number of times the datacast advertisement is to be displayed, the point in the datacast when the datacast advertisement should be displayed, whether the datacast advertisement is Independent or Related to a new or existing analog audio advertisement, and where or how to locate the datacast advertisement for this order (or instructions to the AP on how to create the datacast advertisement if it does not yet exist).

The sales person will also negotiate a fee for the datacast advertisement and will enter the agreed upon rate into the Datacast SOES as well. Similar to sales systems for the analog audio side of the station's broadcast, the Datacast SOES enables the salesperson to save the order for later viewing or editing, as well as the ability to finalize the order and enter it into the system of the present invention system, where it will be processed accordingly.

Datacast Advertisement Placement:

Datacast advertisement placement is an important concept to the system of the present invention as it is a remarkable innovation to the familiar concept of advertisement placement in traditional analog audio broadcasts. With DAB, more placement opportunities exist, including, but not limited to, the ability to display a visual or audio datacast advertisement during a song, which has never been possible over the same broadcast signal until now. Additionally, datacast advertisements could be displayed during audio advertisements—those of the datacast advertiser (as in the case of an RDA) or those of his competitor or those of a completely unrelated advertiser.

Datacast advertisements can also be displayed during the display of other datacast advertisements (particularly in receivers that support large viewing screens that can be divided into multiple viewing areas). And they can also be displayed by location on such receivers, defined by such parameters as the specific area and size of that area (thus constituting a location) as well as their length to display in that location, among others. Datacast Advertisements can also be displayed during station content, such as weather and traffic announcements, as well as during datacast content elements, which is the datacast equivalent of weather and traffic announcements and described in more detail in the section entitled “Datacast Content Elements”.

Once the salesperson has finalized an order, it is sent the Datacast TS, where it is stored for review by the station's appointed Traffic Manager. The Traffic Manager is able to review the order in its entirety and check for any errors or omissions. The Traffic Manager checks a variety of things, including ensuring that the correct client is on the order, that the associated datacast advertisement exists and is present in the system, that the scheduling instructions for the datacast advertisement fit the parameters set forth by the station (in most cases these parameters are set by the Traffic Manager), etc. If a problem is discovered, the Traffic Manager is able to not approve the order and notify the salesperson that there is a problem that must be corrected. If a finalized order appears to be in perfect order, then the Traffic Manager approves the order and it is processed by the system of the present invention system and prepared for insertion into the station's datacast.

The Datacast TS has another very important feature, Data Scheduling. Data Scheduling allows a Traffic Manager to 1) subscribe to a Datacast Content Package 2) choose their preferred provider for that package and 3) schedule all datacast content throughout their datacast.

Datacast Content:

Datacast Content is a generic term applied to a specific category of datacast elements that the system of the present invention provides its member network stations for use with their datacasts. There are specific categories of Datacast Content as well, including weather, traffic, and news. But Datacast Content can also refer to items such as Sports News, Stock Quotes, Business Headlines, and other categories of content that may be more suitable for specific station formats.

Much like station content (as described in the section entitled “Station Content”), Datacast Content is meant to inform the “viewing” audience as well as give “listeners” a compelling reason to occasionally “interact” with their IBOC receiver screens for the benefit of datacast advertisers. Additionally, Datacast Content can also be audio data that is requested by the user for purposes of listening to that specific piece of content at their discretion. Thus, each Datacast Content category has its own “package” from which a station can choose. Within each package, there might be (when the situation permits) multiple third party providers for that Datacast Content in an effort to offer the broadcaster a choice that is most suitable for his station format and audience.

Once the station has selected the Datacast Content package(s) that it deems necessary, the Traffic Manager, Station Manager, or like person, will have to schedule those Datacast Content packages into their data broadcast. Typically, this will consist of the Traffic Manager choosing the Datacast Content package, create a new schedule, give the new schedule a referring title, and choose the provider (when applicable) that they would like to use for this Datacast Content package's schedule. Then the Traffic Manager must select the date for which this Datacast Content schedule starts. Once the Datacast Content schedule contains these parameters, the Traffic Manager can say how many times he wants that particular Datacast Content to appear in the datacast for that particular schedule's dates, as well as the specific days of the week it should appear and the specific programming events that should trigger it to appear as well.

For example, a Traffic Manager wants to display Weather Datacast Content during the morning drive times of his station's datacast and subscribes to receive the Weather Datacast Content Package from the system of the present invention on a regular basis. In order to make the Weather Datacast Content begin to appear in the datacast, the Traffic Manager creates a new Weather Datacast Content schedule. He indicates that he wants “KSWeather” (a fictitious company for purposes of this example that has contracted with the system of the present invention to provide weather data for Weather Datacast Content Packages) to be the Weather Datacast Content provider since he runs a Kansas station and they have a good reputation for local Kansas weather information. He then indicates when he would like to start running this Weather Datacast Content by entering a start date. Once that information has been entered, he can set the number of times to display that Weather Datacast Content and have it only display on the weekdays (exclude Sat and Sun) and set it to display specifically during his Morning Drive daypart. The Traffic Manager can now see Weather Datacast Content on his datacast—only Monday through Friday, from 7:00 am to 10:00 am. Each Datacast Content must have its own schedule and activation protocols. Additionally, a Traffic Manager can create multiple schedules for each Datacast Content package. All the actual data delivered as part of the Datacast Content package is provided by third party providers for that specific type of Datacast Content and is aggregated and maintained by the system of the present invention according to the methods set forth in the section entitled “Datacast Content Aggregation.”

A key aspect of Data Scheduling that should be noted is that the system of the present invention does not enable the Traffic Manager to specify exactly the number of times Datacast Content displays over a specific period. Datacast Content is not associated with a station cut number (“cut”), rather it is inserted when the black box has determined that there is an opportunity to do so, thus recognizing an OCA. This process is described in detail in the section entitled “Multipurpose Internet Device” above.

The system of the present invention has been designed to complement or augment the analog audio broadcast, thus requiring cues from the broadcast and delivering specific datacast elements to the datacast when appropriate. Therefore, the analog broadcast controls the “clock” and is the only part of the broadcast that will be regularly scheduled by the station. Much of what the system provides happens during OCAs, all other data is delivered when triggered by a SCN. The only way for a Traffic Manager to guarantee the delivery of a set number of Weather Datacast Content (in the example above) during the datacast would be for him to associate all Weather Datacast Content with the cut ID for weather announcements over the analog broadcast and base it on that number of weather announcements.

Finally, it is important to discuss another aspect of the Datacast TS, and that is its ability to analyze and store all the APL generated by the station's black box. Much like in the traditional broadcast environment, APLs are necessary to ensure that everything that was scheduled to play during the datacast was actually delivered to the IBOC transmission by the Internet appliance or “black box.” In accordance with the invention, (and discussed in greater detail in the section entitled “Multipurpose Internet Device), the system of the present invention has devised a way to generate APLs for the datacast, which are then uploaded to the system of the present invention's data repository and stored. They are available to the Traffic Manager through the Datacast TMA, where the APLs can be retrieved from the data repository and analyzed. The Traffic Manager is then able to determine which pieces of Datacast Content and which Datacast Advertisements (in other words, all the datacast elements) were “bumped” from the datacast and then initiate make-good actions when appropriate. This is necessary for the proper billing and accounting of sales orders involving datacast advertisements.

The system of the present invention recognizes the fact that it is common in the industry for multiple stations to share one sales force. Additionally, multiple stations may also share other familiar station resources, such as Traffic Managers and Program Directors. The Datacast SOES and Datacast TMA were designed to allow for these common station dynamics and are therefore flexible enough for one salesperson to enter datacast advertisement orders for multiple stations, or have one Traffic Manager approve datacast advertisement orders for multiple stations. By example, the system of the present invention is an extended sales force for every station in its network.

Data Aggregation and Transformation:

In general a radio station is not in the business of producing content. Where as they may produce some content, or provide content via a talk format, a majority of their current audio content such as news, weather, music, traffic reporting, ads, etc. is purchased, bartered for, or contracted to play by the radio station. Additionally, this content can be delivered to a radio station in a multitude of formats, from a variety of sources, on different schedules. Some of the content has a short life span such as news, weather, or traffic information, and must continually be produced. Other content is produced once and used over and over, such as music or a particular ad.

There are many ways in which the radio station receives this content. Music generally comes once by mail in the form of a compact disc, or may be delivered by a music company representative. The radio station uses equipment to transfer this content to its electronic music library. Ads may come digitally via satellite feed or a network such as the Internet, or delivered on a media, such as a tape, by mail. News reports can come in from a wire service such as AP or Reuters. Many radio stations produce weather segments by obtaining the weather from free services such as the national weather service, or from various Internet sources. Other programs such as syndicated shows or traffic reports are fed in from other broadcast facilities. The originating formats for all of this content can vary greatly and the radio station must maintain several different systems for transferring it to their on-air systems.

Consequently, the present invention provides a process for collecting datacast content from varying sources on a continual basis and preparing it for transmission with audio such that a receiver could render the data in a complimentary fashion. The system provides a single source and a central repository for all of the content used by radio stations for datacasts by performing the tasks of aggregating and formatting the data from various sources, as well as storing and securing it. This aggregation system provides transformation processes for all types of data as described above. This includes data that is continually refreshed, produced on a one time basis, fed in from a wire or Internet source, an advertising agency, etc. The repository also reduces the amount of total content required for all radio stations since much of the content that is used by radio stations is the same (e.g., music information, traffic reports in the same city, etc.) Furthermore, the invention makes wholesale improvements on the delivery of data as compared to the delivery of audio by providing a uniform schema for understanding the data, as described above in the section titled “data.”

Additionally, radio stations and advertisers have systems and tools that allow for the production of audio content for broadcast. These may be used to create station promos, jingles, ads, programming content, etc. Thus, the invention provides tools that allow radio stations and advertisers to produce their own data content that is stored in the repository in the uniform schema that is provided the invention. A detailed description of these tools is given in Section DAPS. All this data is placed in the repository.

Finally, the data collected by the sales order entry and trafficking systems described in the section titled “Data Trafficking and Scheduling” must be package for distribution to the individual radio stations that are responsible for fulfilling the requests for orders and content. Consequently, the system provides a process for extrapolating this data and packaging it in an appropriate manner for each station as is needed by the device described in the section titled “Data Automation” on a regular and timely basis.

Data Communication through the Network:

An essential aspect in the streamlining of the data acquisition process of the system is the ability to have data seamlessly transferred to a radio station after it has been aggregated and placed in the repository in a timely manner on a continual basis.

In accordance with this, the present invention provides that bi-directional data transfers are required to occur between the repository and each individual radio station. A preferred method for conducting the communication is to have a device located at the radio station that initiates a data transmission request through any wide area network connection, whether this is the Internet, a point-to-point connection, etc. to the repository. For the purposes of this document communicating in this fashion will be termed communicating on or with “the network”.

The device will initiate a data transmission with the network to receive or send data. For example, the repository contains information on orders for ads that have been placed through the SOES as described in the section titled “Data Trafficking and Scheduling”. On a regular basis as it deems necessary, the device will ask the repository for these orders, and any content and other radio station specific data that it requires as defined in the section titled “Data Automation”. In another case, the device will initiate a data transfer to send data to the network, such as the case where the device reports activity back to the server, so that the radio station personnel can verify order and content placement in the datacast.

The determination that data needs to be retrieved depends upon the nature of the data. Orders, for example, are most efficiently retrieved on a daily or bi-daily schedule as dictated by the activity of the radio station sales force and production staff. Music data, on the other hand, can be retrieved more infrequently as the composition of a station's audio library does not change as often. In the case of more ephemeral data, such as weather, news, and traffic, etc., such data will need timely and frequent updates, up to the minute in some cases.

Multiple types of data may be sent and/or received during a single transmission. For this purpose a request mechanism (for the device) and response mechanism (for the repository) exists for each type of data. A request mechanism will have the responsibility of identifying the type of data, recipient and method of transfer to the network. Likewise the response mechanism will have the responsibility of accepting a request and responding with the appropriate data. For example, there is a specific request mechanism presiding with the device and a response mechanism presiding with the repository for the transfer of order information as given in the example above, as well as a specific request mechanism presiding with the device and a response mechanism presiding with the repository for the activity log.

In order to maintain data integrity, all transmission for a specific data type will occur under a “transaction”. In this case, a transaction is a complete system process affecting the state of the data and the system that either commits or rolls back. If a transaction commits, all of its effects remain and the state of the data and the system will permanently change. If it rolls back, then all of its effects are undone and the system is returned to its previous state. A transaction always leads to a correct transformation of system state.

The invention defines an optimal placement of the burden of creating and policing transactions upon the response mechanism. In this way, the response mechanism will start a new transaction, when necessary, for a particular request. The device will process the response and send an acknowledgment to the network that indicates whether the processing completely succeeded or experienced a failure during processing of the data transmission. Upon receipt of the acknowledgment the network will close the transaction or continue onto the next step of the transaction if multiple steps are required. The data state of failed transactions must be recoverable in all situations.

Multipurpose Internet Device:

In order to create a datacast as is described by the invention the data portion must be synchronized with the audio portion of the broadcast. Synchronization is used here to indicate that the elements of the data portion and the audio portion must be timed properly in order to coincide and provide a complimentary broadcast. The job of physical synchronization is beyond the scope of the invention. However, the invention provides all of the appropriate information in a timely manner to any device responsible for such synchronization and broadcast.

Thus, the invention provides for a mechanism that monitors the systems in a radio station responsible for the audio portion of the broadcast. The mechanism will have the responsibility of notifying a device that interacts with the data that has been transferred via the network and the stations digital transmission systems of the state of the audio broadcast. This includes the means to uniquely identify the currently playing audio as well as the upcoming audio selection. The monitoring mechanism will have the ability to provide the length of the audio selection or selections, the genre, and other attributes associated with audio selections as defined by the audio system. The monitoring mechanism will function as a proxy between the audio system and the device that fulfills opportunistic commercial avails (OCAs) and noncommercial avails (“ONCAs”) as well as the SCNs defined in Section TAO.

An opportunistic avail, whether it is commercial, in other words an ad that was sold through the SOES, or non-commercial such as a data weather report that was scheduled in the trafficking system is an opportunity to place data in the broadcasts to coincide with the audio portion at a given moment. These “avails” can be determined based upon any of the criteria as set forth by the sales order entry and trafficking systems. They are also determined by the concept of related and independent as described in the section titled “Data”.

The device will dynamically build a set of avails and fill them with data based upon the criteria indicated in the previous paragraph as well as time the audio space is expected to air and the length of the audio selection.

Radio Commerce or “rCommerce”:

The present invention provides a network that can move data from its source through a radio station, insert it into a broadcast, and delivery it to a user. The invention also provides a communication architecture for receiving information back from the user. This communication is dependent upon the communication capabilities of the receiver. Receivers that can communicate via the Internet or some other wide area network communication architecture can return data to a central point. This return data transmission, sometimes referred to as the “return path,” could also be provided by devices not working in conjunction with the receiver, such as a WAP device or PC. The data returned provides information about the user, information about the data that was being rendered and information regarding the action that the user desired to be performed. These actions are predefined by the invention and are tied to the data in the broadcast. The definitions for these data elements are encapsulated in the uniform schema that is provided by the invention as detailed in Section titled DATA.

The data returned from the receiver is delivered to a gateway provided by the invention. The delivery address for the gateway is determined by information in the uniform data schema provided by the invention (see Section titled DATA). The roll of the gateway is to listen for requests from radio receivers, validate the data received, perform the action indicated in the data on behalf of the user and return information back to the user as to the status of the request.

The gateway listens on a publicly accessible network such as the Internet. This network must be reachable by the device sending the request. The invention provides that the gateway can listen on a multiple of protocols (HTTP, WAP, etc.) as determined by the capabilities of the device sending the request.

The gateway interacts with an order fulfillment device that takes the information in a data object and conducts a predefined transaction. The concept of order does not necessarily indicate a financial transaction, but can be any action that the invention defines. The result can be a purchase of an item, a request for more information via e-mail or mail, a response back to the radio station originating the broadcast, etc.

The information provided to the gateway and the order processor represents the minimum amount of information that the user needs to send to perform the action. The system provides all of the pertinent information. A portion of this data is supplied in the broadcast, and a portion of this is provided by the system itself. The data that is returned identifies the user via a code of some sort, the action command, and all or a portion of the content that was broadcast that relates to the request. All other information already resides in the system and is provided ahead of time by the user and by the system itself. For example, users provide purchasing information (credit card information, delivery address, e-mail address, preferences, etc.) to the system prior to conducting transactions. Each transaction defines the information it needs from the users as well as the information the providers need to conduct the transaction and obtains this information from the user information based upon the identity of the user.

An illustration of this is the case when the user likes, and ostensibly wants to purchase, a particular song. By interacting with the radio in some fashion, such as by pressing a button, or verbally issuing a command to a voice response system in the radio, the user can initiate an action in the receiver (or some other device as explained above) that sends a signal back to the gateway. Such functionality in a receiver is not covered by this patent and is not in the domain of the invention, but rather a product of the developing receiver capabilities brought about by receiver, auto, and automotive computer system manufacturers as well as wireless communication device manufacturers. The information is received by the gateway, validated, and handed to the order processor. The order processor uses the command in the request information to trigger an action. In this example, the action may be to send a purchase request to a contracted vendor that sells CDs on behalf of the listener. The listener will have already indicated the mode of delivery for the item and that information is all part of the request.

In another example, the request may simply be to have an e-mail generated to the user requesting the phone number and more information regarding an ad they heard or viewed.

In each case, the level of user interaction required at the time the data is viewed of displayed is exactly the same.

The present invention has been described in detail, including the preferred embodiments thereof. However, it will be appreciated that those skilled in the art, upon consideration of the present disclosure, may make modifications and/or improvements on this invention and still be within the scope and spirit of this invention as set forth in the following claims.

What is claimed is:

1. A method for providing data for a digital audio broadcast comprising the steps of:
(a) selecting content for the broadcast;
(b) selling advertising time for content selected;
(c) creating data for content selected and advertising time sold;
(d) aggregating content and advertising data together;
(e) transferring aggregated content and data to a remote sight; and
(f) incorporating transferred aggregate into digital audio broadcast.

2. The method of claim 1, wherein a user has the ability to track the selection of content, advertising time sold, and creation of advertising data.

3. The method of claim 1, further comprising the step of receiving consumer response to aggregate content and advertisement.

4. The method of claim 1, wherein the selecting of content is accomplished using web-based software.

5. The method of claim 1, wherein the selling of advertising time is accomplished using web-based software.

6. The method of claim 1, wherein the selling of creating of data for ad time sold is accomplished using web-based software.

7. The method of claim 2, wherein the tracking of selection of content, advertising time sold and the creation of content are accomplished using web-based software.

8. The method of claim 1, wherein the content for the broadcast is visual in nature.

9. The method of claim 1, wherein the content for the broadcast is auditory in nature.

10. The method of claim 1, wherein the ad data is visual in nature.

11. The method of claim 1, wherein the ad data is auditory in nature.

12. The method of claim 1, wherein step (a) is conducted in a data repository.

13. The method of claim 1, wherein step (b) is conducted in a data repository.

14. The method of claim 1, wherein step (c) is conducted in a data repository.

15. The method of claim 1, wherein step (d) is conducted in a data repository.

16. The method of claim 1, wherein step (e) is conducted on a data network.

17. The method of claim 1, wherein step (f) is conducted by an Internet appliance.

18. The method of claim 1, wherein step (a) further includes the steps of:
(1) selecting the time at which the content will be broadcast;
(2) selecting the length of time the content will be broadcast,
(3) selecting the frequency of broadcast,
(4) selecting if the content will correspond to a particular audio portion of the digital audio broadcast;
(5) selecting the location of the content on a receiving device;
(6) selecting the specific station from which the content will broadcast; and
(7) selecting the starting and ending dates for conducting the above steps.

19. The method of claim 1, wherein step (b) further includes the steps of:
(1) selecting the criteria for advertisement;
(2) selecting the time at which the content will be broadcast;
(3) selecting the length of time the content will be broadcast;
(4) selecting the frequency of broadcast;
(5) selecting if the content will correspond to a particular audio portion of the digital audio broadcast;
(6) selecting the location of the content on a receiving device;
(7) selecting the specific station from which the content will broadcast;
(8) selecting the unit price or cost for broadcasting data; and
(9) selecting the starting and ending dates for the above.

20. The method of claim 1, wherein step (c) further comprises the steps of:
(1) viewing the parameters from steps (a) and (b);
(2) uploading or downloading data for creation; and
(3) complying with standards for IBOC digital audio broadcast.

21. The method of claim 1, further including the step of dynamically monitoring the audio broadcast portion of the digital audio broadcast by an Internet appliance.

22. The method of claim 1, wherein step (e) is accomplished using standardized XML schema for data packaging.

23. The method of claim 1, wherein step (e) is accomplished using HTTP/SSL communication.

24. A system for providing data for a digital audio broadcast having a central server where the data for the digital broadcast is compiled, a data network for transferring the compiled data, and an Internet appliance connected to both the central server and the data network, for receiving the transferred data and incorporating the data into the digital audio broadcast.

25. The system of claim 24, wherein a user has the ability to track the selection of content, advertising time sold, and creation of advertising data.

26. The system of claim 24, further comprising data storage for receiving consumer responses to aggregate content and advertisements.

27. The system method of claim 24, wherein the selection of content is accomplished using web-based software.

28. The system of claim 24, wherein the selling of advertising time is accomplished using web-based software.

29. The system of claim 24, wherein the selling of creating of data for ad time sold is accomplished using web-based software.

30. The system of claim 25, wherein the tracking of selection of content, advertising time sold and the creation of content are accomplished using web-based software.

31. The system of claim 24, wherein the content for the broadcast is visual in nature.

32. The system of claim 24, wherein the content for the broadcast is auditory in nature.

33. The system of claim 24, wherein the advertising data is visual in nature.

34. The system of claim 24, wherein the advertising data is auditory in nature.

35. The system of claim 24, further including software and/or hardware for:
(1) selecting the time at which the content will be broadcast;
(2) selecting the length of time the content will be broadcast,
(3) selecting the frequency of the broadcast,
(4) selecting if the content will correspond to a particular audio portion of the digital audio broadcast;
(5) selecting the location of the content on a receiving device;
(6) selecting the specific station from which the content will broadcast; and
(7) selecting the starting and ending dates for conducting the above steps.

36. The system of claim 24, further including software and/or hardware for:
(1) selecting the criteria for advertisement;
(2) selecting the time at which the content will be broadcast;
(3) selecting the length of time the content will be broadcast;
(4) selecting the frequency of broadcast;
(5) selecting if the content will correspond to an audio portion of the digital audio broadcast;
(6) selecting the location of content on receiving device;
(7) selecting the specific station from which it will broadcast;
(8) selecting the unit price or cost for broadcasting data; and
(9) selecting the starting and ending dates for the above.

37. The system of claim 24, further including software and/or hardware for:
(1) viewing the parameters from steps (a) and (b);
(2) uploading or downloading data for creation; and
(3) complying with standards for IBOC digital audio broadcast.

38. The system of claim 24, further comprising an Internet appliance comprising software and/or hardware for dynamically monitoring the audio broadcast portion of the digital audio broadcast.

39. A system for providing data for on a digital broadcast comprising the steps of:
(a) providing a central server;
(b) providing an Internet appliance;
(c) providing a data network connecting the central server and the Internet appliance;
(d) providing a device for taking orders for advertisements on broadcast on the central server;
(e) providing a device for creating data for broadcast on the central server;
(f) providing a device for aggregating data on the central server for transfer to the Internet appliance;
transferring aggregated data over data network;
(g) providing a device for receiving data transferred over data network on the Internet appliance; and
(h) providing a device for incorporating received data into an IBOC digital broadcast using the Internet appliance.

40. The system of claim 39, wherein a user has the ability to track the selection of content, advertising time sold, and creation of advertising data.

41. The system of claim 39, further data storage for receiving consumer response to aggregate content and advertisement.

42. The system method of claim 39, wherein the selection of content is accomplished using web-based software.

43. The system of claim 39, wherein the selling of advertising time is accomplished using web-based software.

44. The system of claim 39, wherein the selling of creating of data for ad time sold is accomplished using web-based software.

45. The system of claim 39, wherein the tracking of selection of content, advertising time sold and the creation of content are accomplished using web-based software.

46. The system of claim 39, wherein the content for the broadcast is visual in nature.

47. The system of claim 39, wherein the content for the broadcast is auditory in nature.

48. The system of claim 39, wherein the advertising data is visual in nature.

49. The system of claim 39, wherein the advertising data is auditory in nature.

50. The system of claim 39, further including software and/or hardware for:
(1) selecting the time at which the content will be broadcast;
(2) selecting the length of time the content will be broadcast;
(3) selecting the frequency of the broadcast;
(4) selecting if the content will correspond to a particular audio portion of the digital audio broadcast;
(5) selecting the location of the content on a receiving device;
(6) selecting the specific station from which the content will broadcast; and
(7) selecting the starting and ending dates for conducting the above steps.

51. The system of claim 39, further including software and/or hardware for:
(1) selecting the criteria for advertisement;
(2) selecting the time at which the content will be broadcast;
(3) selecting the length of time the content will be broadcast;
(4) selecting the frequency of the broadcast;
(5) selecting if the content will correspond to a particular audio portion of the digital audio broadcast;
(6) selecting the location of the content on a receiving device;
(7) selecting the specific station from which the content will broadcast;
(8) selecting the unit price or cost for broadcasting data; and
(9) selecting the starting and ending dates for conducting the above steps.

52. The system of claim 39, further including software and/or hardware for:
(1) viewing the parameters from steps (a) and (b);
(2) uploading or downloading data for creation; and
(3) complying with standards for IBOC digital audio broadcast.

53. The system of claim 39, further comprising software and/or hardware for dynamically monitoring the audio broadcast portion of the digital audio broadcast via an Internet appliance.

54. A system for providing data on an in-band, on-channel (IBOC) FM digital audio broadcast comprising:
(a) hardware and/or software under control of a client system and providing:
(1) means for requesting content;
(2) means for requesting advertising;
(3) means for creating data; and
(4) means for monitoring the requests and data creation;
(b) hardware and/or software under control of a central server system and providing:
(1) means for receiving requests;
(2) means for storing data;
(3) means for aggregating data for transfer;
(c) hardware and/or software under control of an Internet appliance in communication with parts (a) and (b) defined above, and further providing:
(1) means for receiving transferred aggregate data; and
(2) means for dynamically incorporating data into the IBOC broadcast.

55. The system of claim 54, wherein the user has the ability to track the selection of content, advertising time sold, and creation of advertising data.

56. The system of claim 54, further comprising data storage for receiving consumer responses to aggregate content and advertisements.

57. The system of claim 54, wherein the means for selection of content comprises web-based software.

58. The system of claim 54, wherein the means for the selling of advertising time comprises web-based software.

59. The system of claim 54, wherein the means for the selling of creating of data for ad time sold comprises web-based software.

60. The system of claim 54, wherein the means for tracking of selection of content, advertising time sold and the creation of content comprise web-based software.

61. The system of claim 54, wherein the content for the broadcast is visual in nature.

62. The system of claim 54, wherein the content for the broadcast is auditory in nature.

63. The system of claim 54, wherein the advertising data is visual in nature.

64. The system of claim 54, wherein the advertising data is auditory in nature.

65. The system of claim 54, further including software and/or hardware for:
(1) selecting the time at which the content will be broadcast;
(2) selecting the length of time the content will be broadcast;
(3) selecting the frequency of the broadcast;
(4) selecting if the content will correspond to a particular audio portion of the digital audio broadcast;
(5) selecting the location of the content on a receiving device;
(6) selecting the specific station from which the content will broadcast; and
(7) selecting the starting and ending dates for conducting the above steps.

66. The system of claim 54, further including software and/or hardware for:
(1) selecting the criteria for advertisement;
(2) selecting the time at which the content will be broadcast;
(3) selecting the length of time the content will be broadcast;
(4) selecting the frequency of the broadcast;
(5) selecting if the content will correspond to a particular audio portion of the digital audio broadcast;
(6) selecting the location of the content on a receiving device;
(7) selecting the specific station from which the content will broadcast;
(8) selecting the unit price or cost for broadcasting data; and
(9) selecting the starting and ending dates for conducting the above steps.

67. The system of claim 54, further including software and/or hardware for:
(1) viewing the parameters from steps (a) and (b);
(2) uploading or downloading data for creation; and
(3) complying with standards for IBOC digital audio broadcast.

68. The system of claim 54, further comprising software and/or hardware for dynamically monitoring the audio broadcast portion of the digital audio broadcast.

69. A system for conducting datacast advertisement strategic placement, in which market research data and selection software cooperate to enable a user to efficiently and effectively target specific demographic audiences with their datacast advertisements within an integrated network of datacasters.

70. A process by which the Internet appliance calculates opportunistic commercial avails and opportunistic non-commercial avails for the purposes of inserting appropriate datacast elements into the datacast, said process comprising the steps of:
(a) dynamically monitoring of the audio broadcast by the Internet appliance;
(b) calculating the presence of one or more opportunistic commercial avails and one or more opportunistic non-commercial avails; and
(c) inserting appropriate datacast elements into the datacast based upon said calculations.

71. A method for the processing of transactions between the datacast consumer and the data displayed or heard on an IBOC receiver device, said method comprising the following steps:
(1) maintaining inventory codes that can be applied to and later identify all transactionable datacast elements;
(2) defining actions that can be performed for all transactionable datacast elements;
(3) assigning actions to every transactionable datacast element;
(4) providing a transaction gateway that listens for a consumer's transaction request from any return path;
(5) providing one or more transaction engines that perform the appropriate action for that datacast element and confirms completion of the action for the consumer; and
(6) providing a consumer-centric commerce web site where consumers can setup accounts, gathering all necessary information for the completion of the transaction.
